(19) United States
(12) Patent Application Publication
(10) Pub. No.: US 2026/0339668 A1
(43) Pub. Date: Oct. 29, 2026

(54) ACCELERATOR OFFLOAD DEVICE, ACCELERATOR OFFLOAD METHOD AND PROGRAM

(71) Applicant: NTT, Inc., Tokyo (JP)

(72) Inventors: Ikuo OTANI, Tokyo (JP); Kei FUJIMOTO, Tokyo (JP); Shogo SAITO, Tokyo (JP)

(73) Assignee: NTT, Inc., Tokyo (JP)

(21) Appl. No.: 19/099,790

(22) PCT Filed: Aug. 1, 2022
(86) PCT No.: PCT/JP2022/029437

§ 371 Date: Jan. 30, 2025

(51) Int. Cl. G06F 9/38; G06F 9/48

(52) U.S. Cl. CPC G06F 9/3836; G06F 9/4837; G06F 2209/486

(57) ABSTRACT

An accelerator offload device includes: a device simulation functional unit that enqueues requests in reception queues of the device corresponding to applications; a transfer queue determination unit that determines a transfer queue of the device to have the request, stored in the reception queue, enqueued; and a transfer queue selection unit that executes dequeue instructions to dequeue the requests in preference to the transfer queues having higher priorities, using a predetermined transfer queue selection logic, wherein reception queues are respectively provided for the applications and have the requests enqueued in the transfer queues, and the transfer queues have the requests outputted to a device queue of an accelerator according to the dequeue instruction.

### TECHNICAL FIELD

The present invention relates to an accelerator offload device, an accelerator offload method, and a program.

### BACKGROUND ART

Workloads of specialty (having high throughput therefor) are different depending on types of processors. Central processing units (CPUs) are versatile but are not good at (having low throughput for) a highly parallelized workload, whereas accelerators (hereinafter, appropriately referred to as ACCs), such as a field programmable gate array (FPGA)/(hereinafter, “/” denotes “or”) a graphics processing unit (GPU)/an application specific integrated circuit (ASIC), can compute the workload at high speed with high efficiency. Offloading techniques have been increasingly utilized in which these distinct types of processors are combined and the workload, at which the CPUs are not good, are offloaded to the ACCs and computed, to improve overall computing time and computing efficiency.

In a virtual radio access network (vRAN) or the like, when performance is insufficient and requirements are not satisfied only with a CPU, part of computing is offloaded to an accelerator capable of computing at high speed such as an FPGA and a GPU.

With look-aside type offloading, as illustrated in FIG. 23, a thread of an application (APL) 10 transmits a request to an accelerator 5 included in hardware (HW) 53 through a packet processing API, and receives a response after completion of processing in a polling mode (a method of looping a read function for a device) or an interrupt mode (a method of issuing a read function in response to a hardware interrupt from a device). Accelerator resources to have requests/responses transmitted from/to the thread are fixedly allocated at the time of initialization of the application 10 in units of a device queue 51 and the like. Furthermore, the accelerator 5 processes, in round robin fashion, requests from the device queue 51 that has received the requests from threads (see Non-Patent Literature 1).

### PRIOR ART LITERATURE

### Non-Patent Literature

Non-Patent Literature 1: Documentation of Offloading API for vRAN, Section 5.4.3 [online] [Retrieved on Jul. 14, 2022], the Internet <URL: https://doc.dpdk.org/guides/bbdevs/fpga 5gnr fec.html>; and

Non-Patent Literature 2: J. S. Panchal, et. al., “Enabling and Scaling of URLLC Verticals on 5G vRAN Running on COTS Hardware”, [online] [Retrieved on Jul. 14, 2022] IEEE Communications Magazine, September 2021, the Internet <URL: https://ieeexplore.ieee.org/document/9566562>

### SUMMARY OF INVENTION

### Problems to be Solved

There is a case where two or more applications are installed in a single server and each require different performance. For example, there are ultra-reliable and low latency communication (URLLC) profiles, for highly reliable and low-latency performance, and an enhanced mobile broadband (eMBB) profiles, for ultra-high rate and large capacity performance, in vRAN, in which the former has more strict conditions on latency than the latter.

When processing is offloaded to a plurality of the accelerators 5 in accordance with the requirements of URLLC and eMBB, as illustrated in FIG. 24, for example, the requirements may be satisfied without affecting each other. FIG. 24 illustrates that the applications 10 (APL₁ and APL₂) respectively corresponding to two accelerators 5 are processed in a case where the performance of URLLC is required for APL₁ and the performance of eMBB is required for APL₂. However, since the accelerators 5 that consume large amount of electricity increases in number (here, two accelerators 5), the consumed electricity cannot be reduced.

Another technique (see Non-Patent Literature 2) may be used, as illustrated in FIG. 25, that accelerator resources are individually provided to the applications 10 through virtual functions (VFs) or the like for the accelerators 5, to reduce the accelerators 5 in number and reduce consumed electricity. FIG. 25 illustrates a case where two VFs 55 (VF₁ and VF₂) are provided for a single accelerator 5 to process the applications 10 (APL₁ and APL₂). However, as long as the accelerator 5 is shared, the load from one application 10 may affect the performance of the other application 10.

In a case where the two or more applications 10 are connected to the single accelerator 5 via the VFs 55, requests from the individual VFs 55 are generally processed by the accelerator 5 with the same priority, without being separated. Thus, the requests from the VFs 55 are treated equally, so that throughput of one application 10 can be limited by load amount of the other application 10, or latency time can increase due to load amount of the other application 10.

FIG. 26 shows charts indicating total throughput according to loads of the APL₁ requiring highly reliable and low-latency performance of URLLC and the APL₂ requiring ultra-high rate and large capacity performance of eMBB. In FIG. 26, the horizontal axis of each of the charts of reference numerals 81 and 82 indicates the load amount of APL₂ when the load amount of APL₁ stays constant, and the vertical axis indicates the total throughput of APL₁ and APL₂. With a conventional technique, as shown in the chart of the reference numeral 81 in FIG. 26, when the load amount of the APL₂ increases, the throughput of the APL₁ is affected by the load of the APL₂ (reference numeral “a” the chart of the reference numeral 81) since requests from both of the VFs 55 (FIG. 25) are equally treated. Here, ideally, as indicated in the chart of the reference numeral 82 in FIG. 26, the throughput of the APL₁ with strict requirements on performance desirably stays constant regardless of the load of the APL₂ (reference numeral “b” in the chart of the reference numeral 82).

FIG. 27 shows charts indicating the latency of the APL₁ when the load amount of the APL₂ increases, with the load amount of the APL₁ staying constant. In FIG. 27, the horizontal axis of each of the charts of reference numerals 83 and 84 indicates the load amount of APL₂, and the vertical axis indicates the latency of APL₁. Note that it is assumed that the load amount of the APL₁ stays constant. In the prior art, as shown in the chart of the reference numeral 83, when the load of the APL₂ increases, the latency of the APL₁ also increases, that is, the APL₁ is affected by the load of the APL₂ (reference numeral “c” in the chart of the reference numeral 83). Here, ideally, as indicated in the chart of the reference numeral 84, the latency of the APL₁ with strict requirements on performance desirably stays constant after a predetermined value even when the load amount of the APL₂ increases (reference numeral “d” in the chart of the reference numeral 84).

As described above, in the prior art, there is a problem that the performance value of one application 10 is affected by the load amount of the other application 10 offloaded to the same accelerator 5, to fail to satisfy performance requirements set for the application 10.

The present invention has been devised in view of such a background, and the present invention is intended to prevent performance deterioration of an application due to reduction in electricity consumed by an accelerator and reduce electricity consumed by the accelerator.

### Solution to Problem

An accelerator offload device according to the present invention is an accelerator offload device that includes an accelerator and offloads processing of a plurality of applications having different performance requirements to the accelerator, the device including: a device simulation functional unit that implements an interface function equivalent to that of the accelerator to pretend to communicate with the accelerator, receives requests from the applications, and enqueues the requests in reception queues corresponding to the applications; a transfer queue determination unit that acquires metadata attached to the received requests and determines, per request, transfer queues corresponding to basic priorities indicating priorities of the application according to the performance requirements, as those into which the requests stored in the reception queues are enqueued; the reception queues that are respectively provided for the applications to buffer the requests, and have the requests enqueued therefrom into the transfer queues determined by the transfer queue determination unit; a transfer queue selection unit that executes dequeue instructions to dequeue the requests in preference to the transfer queues having higher priorities, using a predetermined transfer queue selection logic, based on priorities associated with the transfer queues; and the transfer queues that are provided per priority, buffer the requests, and have the requests outputted to a device queue of the accelerator according to the dequeue instructions.

### Advantageous Effects of Invention

The present invention prevents performance deterioration of an application due to reducing electricity consumed by an accelerator and reduces electricity consumed by the accelerator.

### BRIEF DESCRIPTION OF DRAWINGS

FIG. 1 shows a functional block diagram of an overall configuration of an accelerator offload device according to the present embodiment;

FIG. 2 shows an example data configuration of reception queue information according to the present embodiment;

FIG. 3 shows an example data configuration of transfer queue determination information according to the present embodiment;

FIG. 4 shows an example data configuration of transfer queue information according to the present embodiment ;

FIG. 5 shows an example data configuration of transfer queue selection information according to the present embodiment;

FIG. 6 is a diagram illustrating overview of order control of processing request executed by the accelerator offload device according to the present embodiment;

FIG. 7 is a diagram illustrating overview of processing amount control executed by the accelerator offload device according to the present embodiment;

FIG. 8 shows an example data configuration of application performance information according to the present embodiment;

FIG. 9 is a chart illustrating a case where a transfer queue selection unit determines a risk of affecting performance of a high-priority application, using latency, and changes a transfer queue selection logic;

FIG. 10 is a chart illustrating a case where a queue upper limit determination unit determines a risk of affecting performance of a high-priority application, using latency, and changes a queue upper limit;

FIG. 11 is a chart illustrating a case where a real-time-based determination unit changes a priority according to a time budget for each request;

FIG. 12 is a chart illustrating a case where a band reservation unit empties a high-priority transfer queue in advance;

FIG. 13 is a sequence diagram of a flow of processing (outward path) executed by the accelerator offload device according to the present embodiment;

FIG. 14 is a sequence diagram of a flow of processing (return path) executed by the accelerator offload device according to the present embodiment;

FIG. 15 is a flowchart of a process to determine transfer queue executed by the accelerator offload device according to the present embodiment;

FIG. 16 is a flowchart of a priority determination process based on a time budget of a time slot;

FIG. 17 is a diagram illustrating an example of a time slot;

FIG. 18 is a flowchart of a transfer queue selection process using weighted round robin processing;

FIG. 19 is a flowchart of a transfer queue selection process using priority order processing;

FIG. 20 is a flowchart of a queue upper limit determination process executed by the accelerator offload device according to the present embodiment;

FIG. 21 is a flowchart of a queue selection ratio determination process executed by the accelerator offload device according to the present embodiment;

FIG. 22 shows an example hardware configuration of a computer that implements functions of the accelerator offload device according to the present embodiment;

FIG. 23 is a diagram illustrating a conventional case where an accelerator is provided in HW and processing of an application is offloaded;

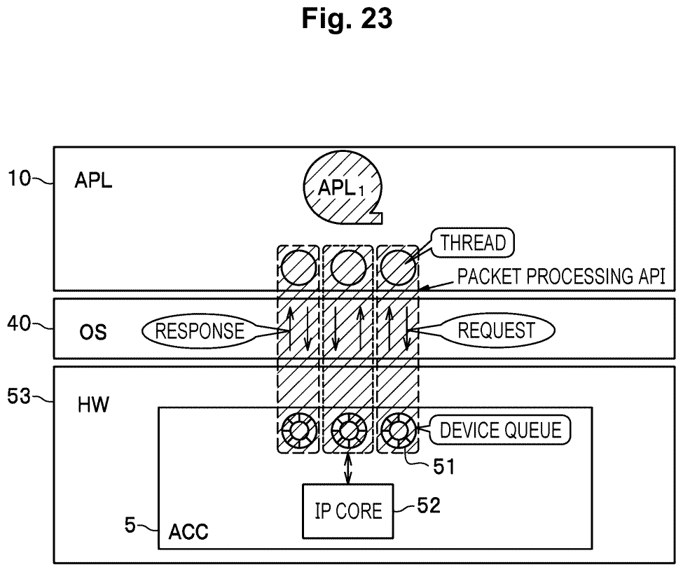

FIG. 24 is a diagram illustrating a case of offloading processing of a plurality of applications having different performance requirements to a plurality of accelerators;

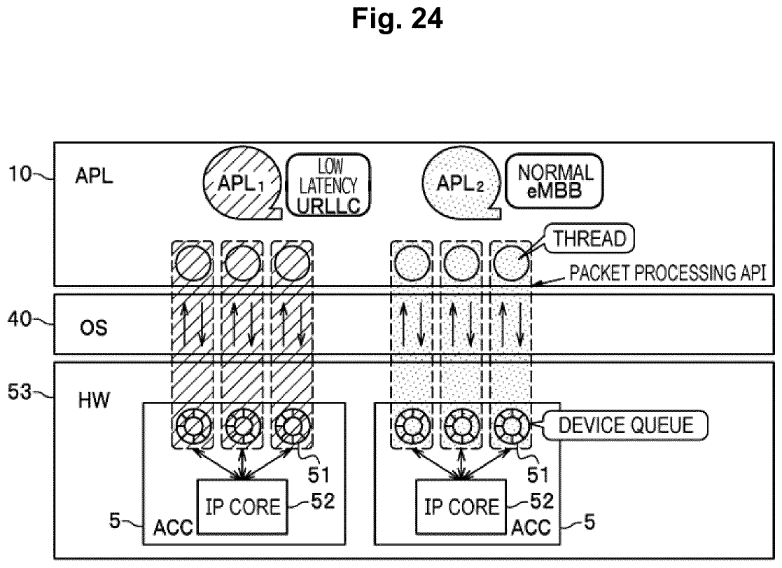

FIG. 25 is a diagram illustrating a case of offloading processing of a plurality of applications having different performance requirements to a single accelerator through a plurality of VFs;

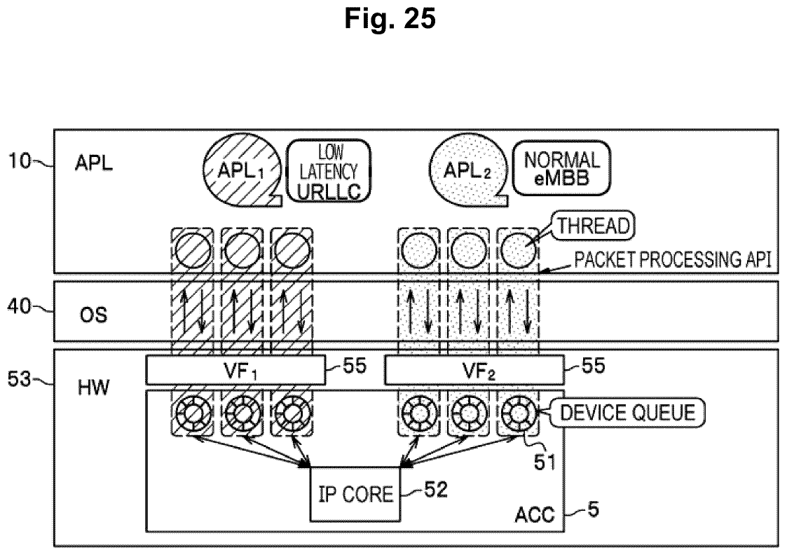

FIG. 26 shows charts indicating total throughput according to loads of an APL₁ requiring performance of URLLC and an APL₂ requiring performance of eMBB; and

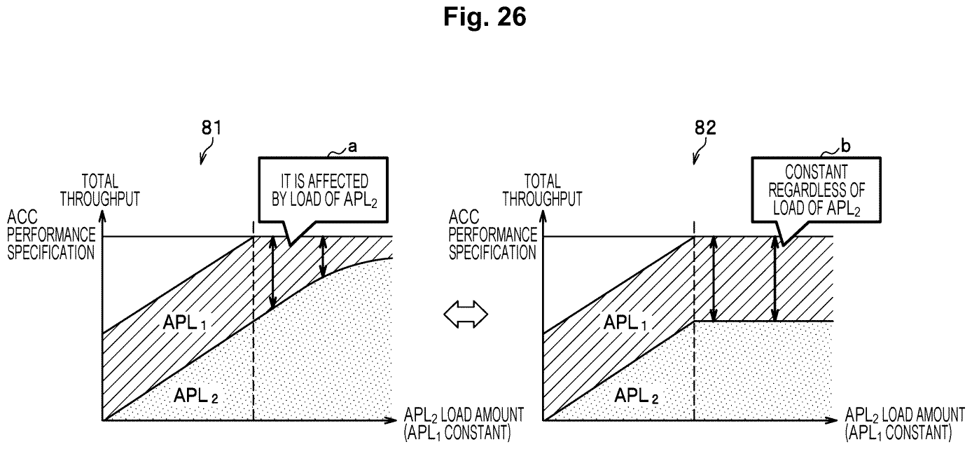

FIG. 27 shows charts indicating latency of the APL₁ when load amount of the APL₂ increases, with load amount of the APL₁ staying constant.

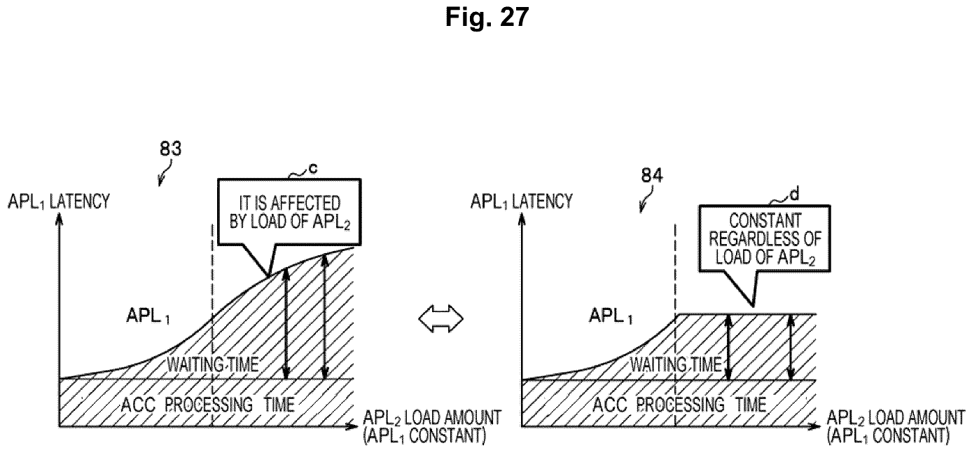

### DESCRIPTION OF EMBODIMENTS

Hereinafter, an accelerator offload device 1 and the like in a mode for implementing the present invention (hereinafter, referred to as “present embodiment”) is described with reference to the drawings.

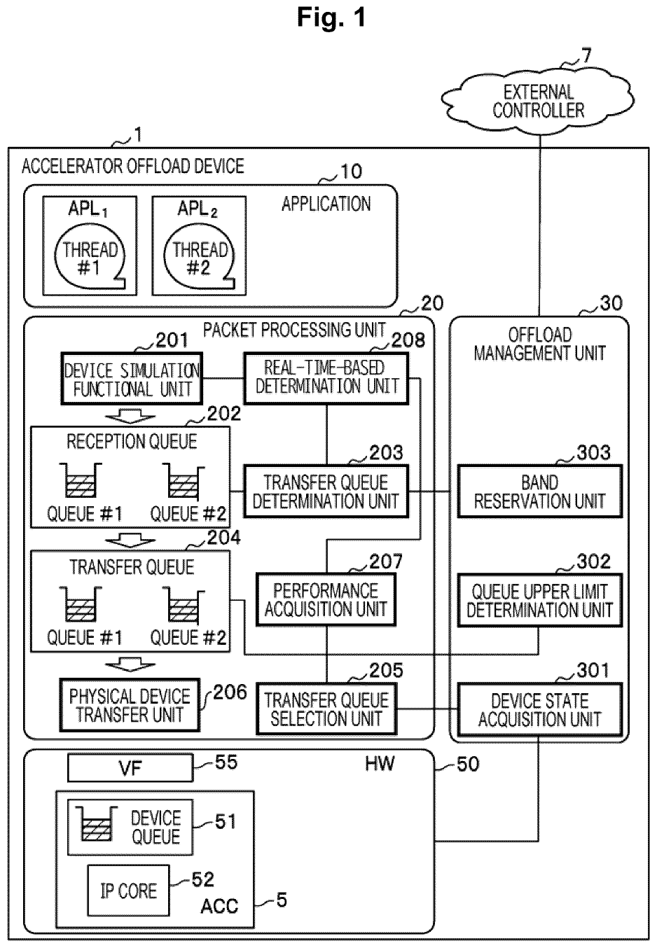

FIG. 1 shows a functional block diagram of an overall configuration of the accelerator offload device 1 according to the present embodiment. The accelerator offload device 1 aims to control amount of resources used by an accelerator 5 equipped therein, for each application 10, when processing of a plurality of applications (APL) 10 is offloaded to the accelerator (ACC) 5. At that time, the accelerator offload device 1 satisfies the following requirements.
(Requirement 1) Application Transparency: Accelerator resources should be used without adding any special functions in an application in order to apply resource amount control,
(Requirement 2) Exclusion of performance impact to high-priority application: Performance impact from processing of other applications should be excluded, based on priority of the application, and
(Requirement 3) Exclusion of dependency on accelerator: No functions should be added to the accelerator for resource amount control.

The accelerator offload device 1 according to the present embodiment is intended to satisfy the above-described (Requirement 1) to (Requirement 3), need not add any functions to the application and accelerator (Requirement 1 and Requirement 3), and specifically regarding (Requirement 2), allows for reducing electricity consumed by the accelerator without affecting performance of other applications even in a case where a plurality of applications runs on a single server, with different performance requirements. Therefore, the accelerator offload device 1 does not adopt a method of performing prioritization and/or order control for requests in the applications and handing over the requests to the accelerator or a method of performing prioritization and/or order control at the accelerator for requests from applications. Instead, a method is adopted in which a proxy provided between applications and a physical device performs prioritization and/or order control for requests from the applications, acquired through a packet processing application programming interface (API), and hands over the requests to an accelerator (a method using the proxy) is adopted. Details of the accelerator offload device 1 is described below.

As illustrated in FIG. 1, the accelerator offload device 1 includes a plurality of the applications 10 including APL₁ and APL₂, a packet processing unit 20, an offload management unit 30, and HW 50. Here, the APL₁ is, for example, a high-priority application 10 that requires highly reliable and low-latency performance of URLLC, and is assumed to have offloading implemented to the accelerator 5 from a thread #1. On the other hand, the APL₂ is, for example, a low-priority application 10 that requires ultra-high rate and large capacity performance of eMBB, and is assumed to have offloading implemented to the accelerator 5 from a thread #2.

The HW 50 includes a physical device such as the accelerator (ACC) 5, and a CPU and a NIC (physical NIC) (which are not illustrated). The accelerator 5 is computing unit hardware that performs specific computing at high speed on the basis of an input from the CPU. The accelerator 5 is, for example, a field programmable gate array (FPGA) or an application specific integrated circuit (ASIC). In FIG. 1, the accelerator 5 is assumed to include one intellectual property (IP) core 52 and a device queue 51 that maintains data in a first-in first-out list structure. Note that the accelerator 5 may be provided with a virtual function (VF 55) thereof described above, as illustrated in FIG. 1, to process data from applications (APL₁ and APL₂), or may process the data without the VF 55.

The packet processing unit 20 is a functional group relaying when packet processing is offloaded to the accelerator 5. Specifically, the packet processing unit 20 is a high-speed data transfer middleware provided in a user space, and comprises a data plane development kit (DPDK), for example. The packet processing unit 20 includes a device simulation functional unit 201, a reception queue 202, a transfer queue determination unit 203, a transfer queue 204, a transfer queue selection unit 205, a physical device transfer unit 206, a performance acquisition unit 207, and a real-time-based determination unit 208.

The device simulation functional unit 201 implements an interface function equivalent to that at the HW 50 so as to simulate the APL₁ and the APL₂ (application 10) to communicate with the accelerator 5. With the device simulation functional unit 201, since it is sufficient for the application 10 to perform the same processing as the direct communication with the accelerator 5, the transparency to the application of (Requirement 1) described above is satisfied. That is, there is no need to add any special functions to the application 10. Then, on receiving requests from the threads (Thread #1 and Thread #2) of the applications 10 (APL₁ and APL₂), the device simulation functional unit 201 enqueues the requests (adds data to the tail of the queue) in the reception queue 202.

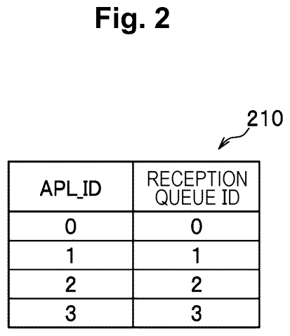

On receiving the request, the device simulation functional unit 201 acquires APL_ID corresponding to the thread that has transmitted the request. Furthermore, the device simulation functional unit 201 acquires metadata added to the request. Then, the device simulation functional unit 201 refers to reception queue information 210 illustrated in FIG. 2 on the basis of APL_ID and stores the request in the reception queue 202 provided to associate with the applications (APL₁ and APL₂).

FIG. 2 shows an example data configuration of the reception queue information 210 according to the present embodiment. As illustrated in FIG. 2, the reception queue information 210 stores the reception queue ID of the reception queue 202 provided to associate with APL_ID of the applications 10. FIG. 2 illustrates a case where four reception queues corresponding to the four applications 10 are provided. Note that the reception queue information 210 is information set in advance and is stored in a storage unit (not illustrated) of the accelerator offload device 1.

On receiving the request, the device simulation functional unit 201 refers to the reception queue information 210 and enqueues the request in the reception queue 202 having the reception queue ID corresponding to APL_ID. Furthermore, the device simulation functional unit 201 outputs the acquired metadata to the transfer queue determination unit 203 in order to perform priority control on a request-by-request basis.

The reception queues 202 are respectively provided for the applications 10 to buffer the requests from the applications (for example, APL₁ and APL₂). Then, the reception queue 202 has the request enqueued in the transfer queue 204 having an appropriate priority according to an instruction from the transfer queue determination unit 203.

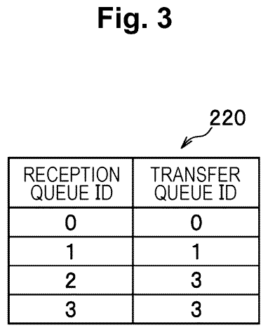

The transfer queue determination unit 203 determines the transfer queue 204, based on priority of the request, in which the request dequeued (data is extracted from the head of the queue) from the reception queue 202 is to be enqueued. At that time, the transfer queue determination unit 203 refers to transfer queue determination information 220 illustrated in FIG. 3, for example, acquires a transfer queue ID corresponding to the reception queue ID of the reception queue 202 to have the request dequeued, and enqueues the request in the transfer queue 204 indicated by the transfer queue ID.

FIG. 3 shows an example data configuration of the transfer queue determination information 220 according to the present embodiment. As illustrated in FIG. 3, the transfer queue determination information 220 stores the transfer queue ID corresponding to the reception queue ID. FIG. 3 illustrates a case where the four transfer queues 204 corresponding to four priorities are provided. Note that the transfer queue determination information 220 is stored in a storage unit (not illustrated).

Furthermore, the transfer queue determination unit 203 determines whether the metadata of the request received from the device simulation functional unit 201 includes information (priority information) for determining the priority. Then, when the priority information (such as information indicating emergency traffic to be described below) is included, the transfer queue determination unit 203 determines the transfer queue 204, having the priority based on the priority information, as one to have the request enqueued (the details is described below).

Moreover, when information regarding the time budget can be acquired on a request-by-request basis even when the priority information is not included in the metadata, the transfer queue determination unit 203 uses the real-time-based determination unit 208, to be described below, to determine the priority and, based on the determined priority, determines the transfer queue 204, on a request-by-request basis, to have the request enqueued (the details will be described later).

The transfer queues 204 are provided so as to correspond to priorities of the requests, to buffer the requests acquired from the reception queue 202.

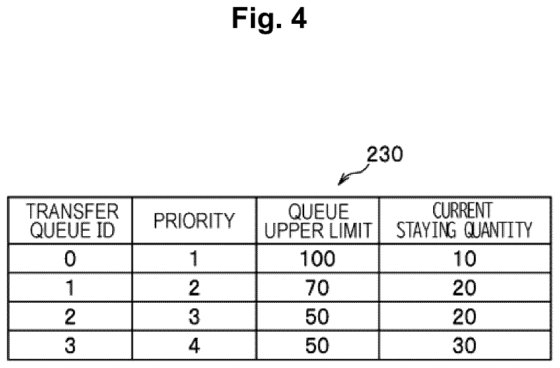

Furthermore, when the requests are buffered into the transfer queue 204, transfer queue information 230 illustrated in FIG. 4 is referred to and if the upper limit value (queue upper limit) of requests that can be enqueued is exceeded as a result, the request can no longer be enqueued, so that the enqueuing into the transfer queue 204 from the reception queue 202 is stopped.

FIG. 4 shows an example data configuration of the transfer queue information 230 according to the present embodiment. As illustrated in FIG. 4, the transfer queue information 230 stores information regarding the priority level, the queue upper limit, and the current staying quantity, in association with the transfer queue IDs of the transfer queues 204. The priority is information indicating the degree of priority of the request stored in the transfer queue 204, and in the example of FIG. 4, priorities “1” to “4” are set in association with the transfer queues 204. Note that the priority “1” is the highest priority, and the priority “4” is the lowest priority. The queue upper limit is information indicating an upper limit value of the number of requests that can be enqueued in the transfer queue 204, and is determined by a queue upper limit determination unit 302 to be described below. The current staying quantity indicates the number of requests currently buffered in the transfer queue 204. Note that the transfer queue information 230 is stored in a storage unit (not illustrated).

The requests are dequeued from the transfer queues 204 in accordance with an instruction from the transfer queue selection unit 205 to be described below, and outputted to the physical device transfer unit 206.

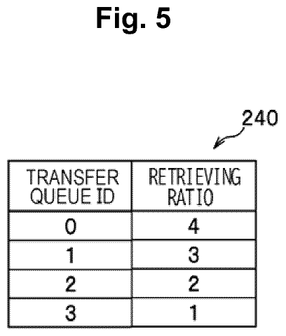

The transfer queue selection unit 205 instructs to dequeue the requests from the transfer queues 204 using a predetermined logic (transfer queue selection logic) based on priorities of the transfer queues 204. For example, the transfer queue selection unit 205 outputs a dequeue instruction to the transfer queue 204 with a preset queue selection ratio (weighted round robin processing) based on priorities of the transfer queues 204. At that time, the transfer queue selection unit 205 refers to transfer queue selection information 240 illustrated in FIG. 5 to determine selection ratios of the requests being dequeued from the transfer queue 204.

FIG. 5 shows an example data configuration of the transfer queue selection information 240 according to the present embodiment. As illustrated in FIG. 5, the transfer queue selection information 240 stores ratios (retrieving ratios) for retrieving requests from the transfer queues 204, in association with the transfer queue IDs of the transfer queues 204. Note that the transfer queue selection information 240 is stored in a storage unit (not illustrated).

The transfer queue selection unit 205 uses information regarding a delay performance value (latency) for each application 10 acquired by the performance acquisition unit 207 to be described below and information based on the number of requests staying in the accelerator 5 and acquired from a device state acquisition unit 301 to be described below, to calculate a queue selection ratio that does not affect performance of the high-priority application. Then, the transfer queue selection unit 205 updates the queue selection ratios (retrieving ratios) of the transfer queue selection information 240 (FIG. 5) on the basis of the calculation result.

The physical device transfer unit 206 receives a request from the transfer queue 204 and enqueues the request in the device queue 51 of the accelerator 5.

### Order Control of Processing Request

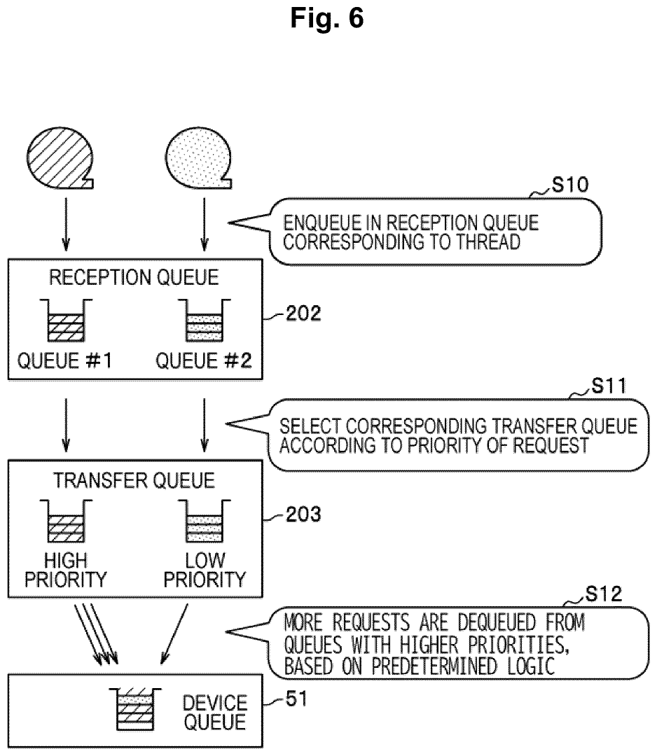

Here, overview of processing request order control executed by the accelerator offload device 1 is described with reference to FIG. 6.

Once the device simulation functional unit 201 has received requests from the threads #1 and #2 of the applications 10 (APL₁ and APL₂), the device simulation functional unit 201 refers to the transfer queue determination information 220 to enqueue the requests in the reception queues 202 corresponding to the applications 10 (APL₁ and APL₂) of the threads #1 and #2 (step S10).

Subsequently, the corresponding transfer queues 204 are selected for the requests in the reception queues 202, based on priorities determined by the transfer queue determination unit 203 (step S11), and the requests are enqueued.

The requests are dequeued from the transfer queues 204 such that more requests are dequeued from queues with higher priorities, on the basis of a predetermined logic (transfer queue selection logic) set in the transfer queue selection unit 205 (step S12), and are enqueued in the device queue 51.

In this manner, the accelerator offload device 1 performs the order control of processing by the accelerator 5 based on priorities of the requests, to satisfy (Requirement 2) or Exclusion of performance impact.

### Processing Amount Control

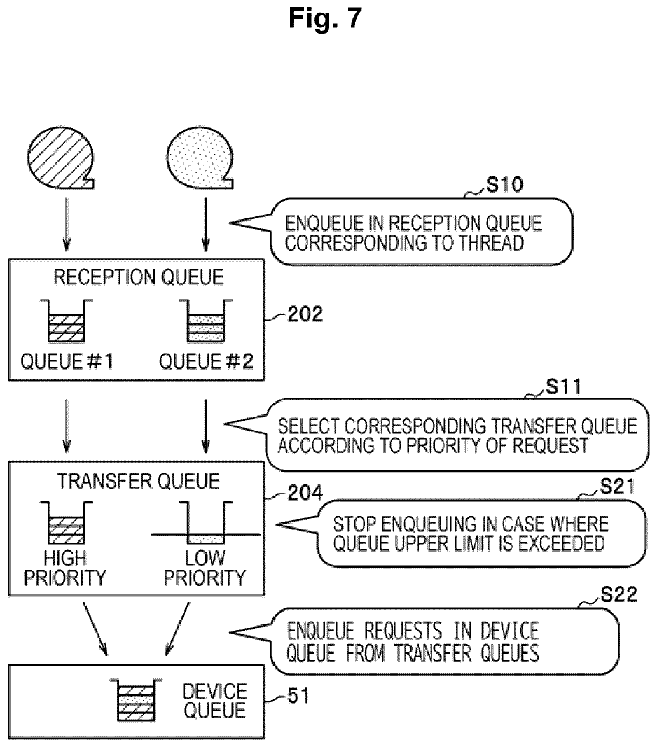

Next, overview of processing amount control executed by the accelerator offload device 1 is described with reference to FIG. 7. Here, since steps S10 and S11 are similar to the processing illustrated in FIG. 6, the same reference numerals are attached and the descriptions thereof are omitted.

When the request is buffered from the reception queue 202, the transfer queue information 230 (FIG. 4) is referred to and if the queue upper limit is exceeded when the request is buffered, the enqueuing into the transfer queues 204 from the reception queue 202 is stopped (step S21).

Subsequently, the requests in the transfer queues 204 are enqueued in the device queue from the transfer queues 204, on the basis of a predetermined logic (transfer queue selection logic) set in the transfer queue selection unit 205 (step S22).

In this manner, the accelerator offload device 1 can transfer the requests to the accelerator 5 in preference to the transfer queues for the high-priority requests, to satisfy (Requirement 2) or Exclusion of performance impact, by performing the processing amount control based on priorities of the requests.

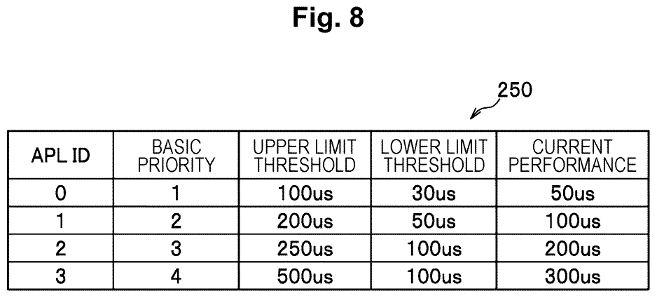

Returning to FIG. 1, the performance acquisition unit 207 acquires a performance delay value (latency) for each application 10 from an interval between a request made the application 10 and the accelerator 5 and a response to the request. Then, the performance acquisition unit 207 outputs the performance delay value (latency) to the transfer queue selection unit 205, the queue upper limit determination unit 302, and the real-time-based determination unit 208. The transfer queue selection unit 205 and the queue upper limit determination unit 302 determine whether the acquired performance delay value (latency) exceeds a predetermined threshold (upper limit threshold and lower limit threshold), with reference to application performance information 250 illustrated in FIG. 8.

FIG. 8 shows an example data configuration of the application performance information 250 according to the present embodiment. As illustrated in FIG. 8, the application performance information 250 stores information regarding a basic priority, the upper limit threshold, the lower limit threshold, and the current performance in association with APL_ID of the application 10.

The basic priority is a priority for the application 10, as a base, and any desired priority that can be set in the transfer queue information 230 (FIG. 4) is allocated in advance. The upper limit threshold is a threshold for determining whether to change the parameter(s) of the transfer queue selection logic and/or the queue upper limit, in order not to affect the performance of the high-priority application 10 when the latency increases. The lower limit threshold is a threshold for determining whether or not to restore the parameter change after the parameter change due to the increased latency. The current performance is the current performance delay value (latency) of the application 10 acquired by the performance acquisition unit 207. Note that the application performance information 250 is stored in a storage unit (not illustrated).

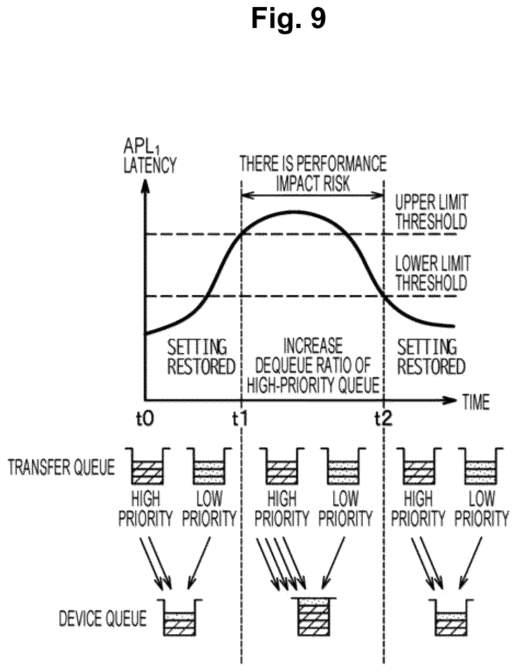

FIG. 9 is a chart illustrating a case where the transfer queue selection unit 205 determines a risk of affecting performance of the high-priority application (APL₁) using latency, and changes the transfer queue selection logic. During a period from time t0 to time t1, the transfer queue selection unit 205 instructs dequeuing at a selection ratio of “2:1” for a high-priority transfer queue and a low-priority transfer queue. Here, at time t1, if the latency of the APL₁ acquired from the performance acquisition unit 207 exceeds the upper limit threshold, the transfer queue selection unit 205 changes the transfer queue selection logic to change the selection ratio between the high-priority transfer queue and the low-priority transfer queue to “4:1”. At time t2, if the latency of the APL₁ becomes smaller than the lower limit threshold, the transfer queue selection unit 205 changes the transfer queue selection logic to restore the selection ratio between the high-priority transfer queue and the low-priority transfer queue to “2:1”.

In this manner, if the latency increases, the accelerator offload device 1 can increase frequency of processing the high-priority application by changing the parameter of the transfer queue selection logic, to satisfy (Requirement 2) or Exclusion of performance impact.

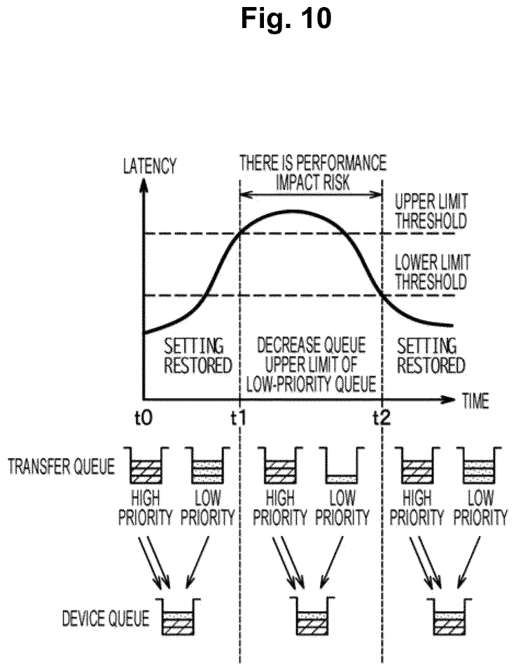

FIG. 10 is a chart illustrating a case where the queue upper limit determination unit 302 determines a risk of affecting performance of the high-priority application (APL₁), using latency, and changes the queue upper limit. During a period from time t0 to time t1, it is assumed that the queue upper limit determination unit 302 has set the same queue upper limit (for example, “100”) to the transfer queue information 230 (FIG. 4) for the high-priority transfer queue and the low priority transfer queue. Here, at time t1, if the latency of APL₁ acquired from the performance acquisition unit 207 exceeds the upper limit threshold, the queue upper limit determination unit 302 decreases the queue upper limit of the transfer queue 204 corresponding to the low-priority application (for example, “30”). Then, at time t2, if the latency of the APL₁ becomes smaller than the lower limit threshold, the queue upper limit determination unit 302 restores the queue upper limit of the transfer queue 204 corresponding to the low-priority application to the original value (for example, “100”).

In this manner, if the latency increases, the accelerator offload device 1. can increase frequency of processing the high-priority application to satisfy (Requirement 2) or Exclusion of performance impact, by changing (decreasing) the queue upper limit of the transfer queue corresponding to the low-priority application.

Returning to FIG. 1, when the priority information is not included in the metadata acquired from the request, the real-time-based determination unit 208 calculates the time budget remaining for the request, on the basis of the imposed time slot. Then, the real-time-based determination unit 208 outputs, to the transfer queue determination unit 203, information indicating that a request with a little remaining time budget should be enqueued in the high-priority transfer queue as a request to be processed first, on a request-by-request basis.

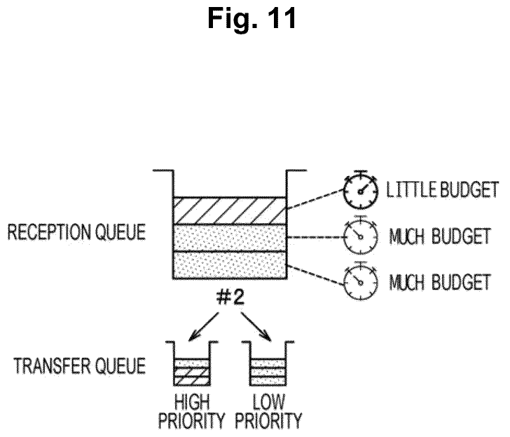

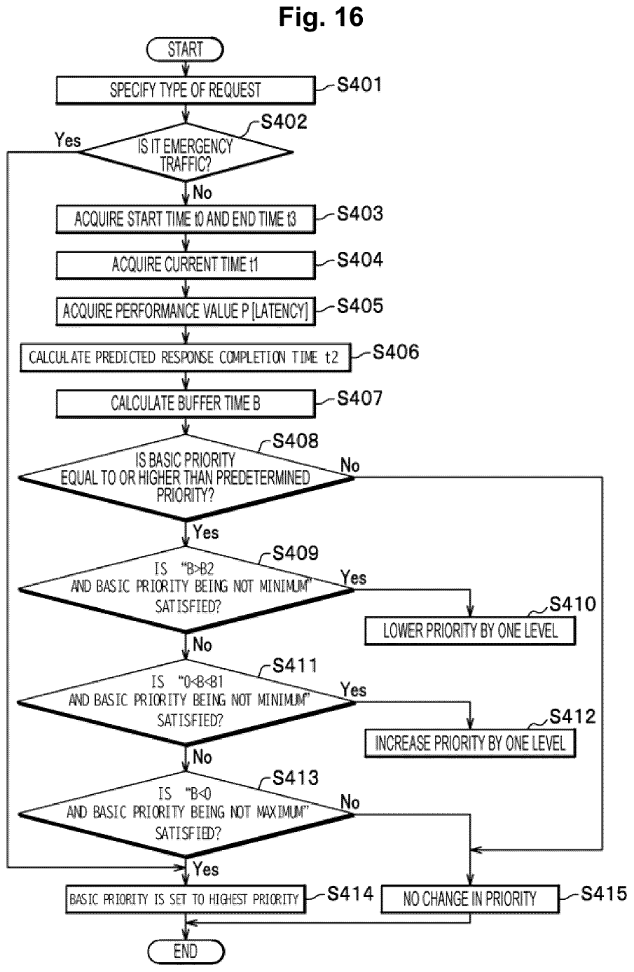

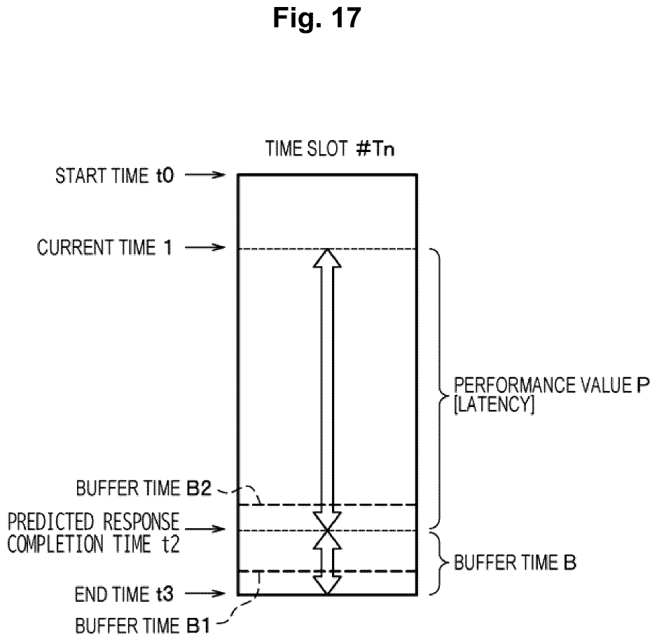

For example, as illustrated in FIG. 11, if the time budget for the request stored in the reception queue 202 corresponding to the thread #2 of the APL₂, which is the low-priority application 10, has little remaining time, the real-time-based determination unit 208 outputs the information regarding this to the transfer queue determination unit 203, to control the request being allocated to the high-priority transfer queue 204. Note that the priority determination process of the real-time-based determination unit 208 is be described below with reference to FIGS. 16 and 17.

In this manner, the accelerator offload device 1 can satisfy (Requirement 2) or Exclusion of performance impact by allocating the request with a little remaining time budget to the high-priority transfer queue 204.

Returning to FIG. 1, the offload management unit 30 controls a process of offloading a request on the basis of information from the HW 50 (accelerator 5) or an external controller 7. The offload management unit 30 includes the device state acquisition unit 301, the queue upper limit determination unit 302, and a band reservation unit 303. As illustrated in FIG. 1, the offload management unit 30 may be provided inside the accelerator offload device 1, or may be provided in a device separated from the accelerator offload device 1 to transmit and receive information to and from the packet processing unit 20 of the accelerator offload device 1.

The device state acquisition unit 301 counts the number of requests staying in the accelerator 5. Then, the device state acquisition unit 301 outputs the counted number of requests staying in the accelerator 5 to the transfer queue selection unit 205 and the queue upper limit determination unit 302. Note that the device state acquisition unit 301 may predict the future latency on the basis of the counted number of requests staying in the accelerator 5, and output the predicted latency to the transfer queue selection unit 205 and the queue upper limit determination unit 302.

The transfer queue selection unit 205 and the queue upper limit determination unit 302 that have acquired the information regarding the number of requests staying in the accelerator 5 (or the predicted latency) from the device state acquisition unit 301 refer to the application performance information 250 (FIG. 8) and the like, to determine whether or not the number of staying requests (or latency) exceeds a predetermined threshold (upper limit threshold and lower limit threshold). Note that when the device state acquisition unit 301 outputs the number of requests staying in the accelerator 5 to the transfer queue selection unit 205 and the queue upper limit determination unit 302, information regarding the upper limit threshold and lower limit threshold for the number of staying requests is stored in a storage unit (not illustrated).

If the number of staying requests (or the predicted latency) exceeds the predetermined threshold (upper limit threshold and lower limit threshold), the transfer queue selection unit 205 performs processing similar to the processing of changing the transfer queue selection logic illustrated in FIG. 9. Furthermore, if the number of staying requests (or the predicted latency) exceeds the predetermined threshold (upper limit threshold and lower limit threshold), the queue upper limit determination unit 302 performs processing similar to the processing of changing the queue upper limit illustrated in FIG. 10.

The queue upper limit determination unit 302 determines the queue upper limits of the requests stored in the transfer queues 204, and sets the queue upper limits in the transfer queue information 230 (FIG. 4). As described above, the queue upper limit determination unit 302 acquires information regarding the performance delay value (latency) from the performance acquisition unit 207 and information regarding the number of requests staying in the accelerator 5 (or the predicted latency) from the device state acquisition unit 301, determines whether the value in the information exceeds the predetermined threshold (upper limit threshold and lower limit threshold), and changes the information regarding the queue upper limit set in the transfer queue information 230 (FIG. 4).

On acquiring a past history of traffic or prediction information indicating that the highest priority requests are transmitted in bursts through the external controller 7 (such as RAN Intelligent Controller (RIC)), the band reservation unit 303 outputs an instruction to the transfer queue determination unit 203 so as to stop enqueuing in the high-priority transfer queue 204 in advance and empty the queue.

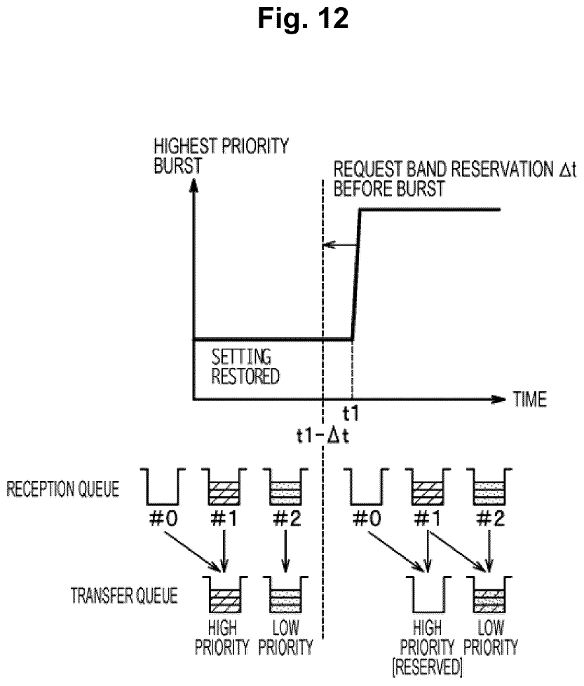

For example, as illustrated in FIG. 12, when it is predicted that the requests of a thread #0 increases in bursts at time t1, the band reservation unit 303 instructs the transfer queue determination unit 203 a predetermined time Δt before time t1 to empty a high-priority transfer queue. The transfer queue determination unit 203 that has received the instruction changes the queue to be allocated to the request stored in the reception queue 202 for the thread #1 from the high-priority transfer queue 204 to the low-priority transfer queue 204, to empty the high-priority transfer queue 204 at time t1.

In this way, the accelerator offload device 1 can minimize a delay of a request when requests are transmitted in bursts, to satisfy (Requirement 2) or Exclusion of performance impact.

### Processing of Accelerator Offload Device

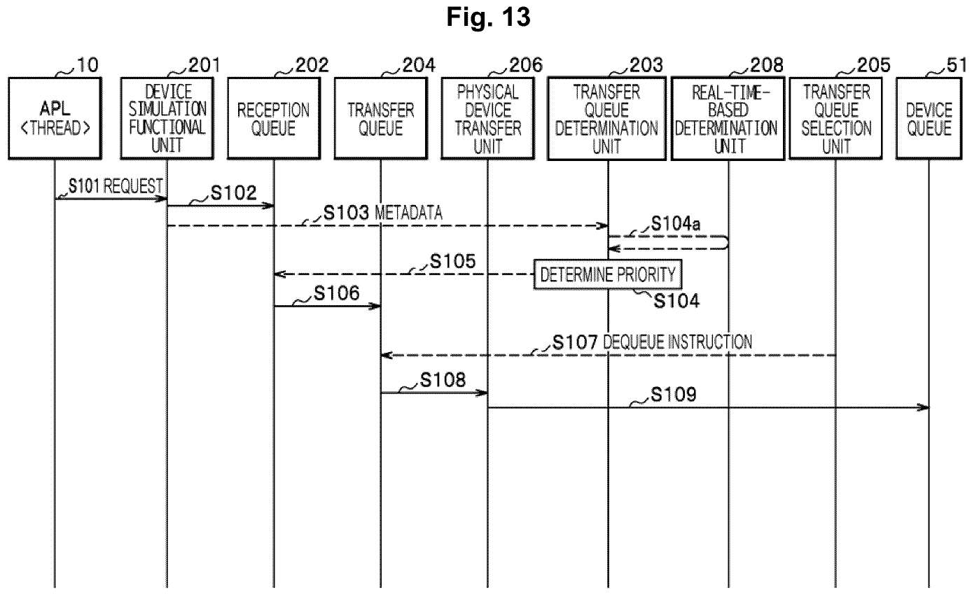

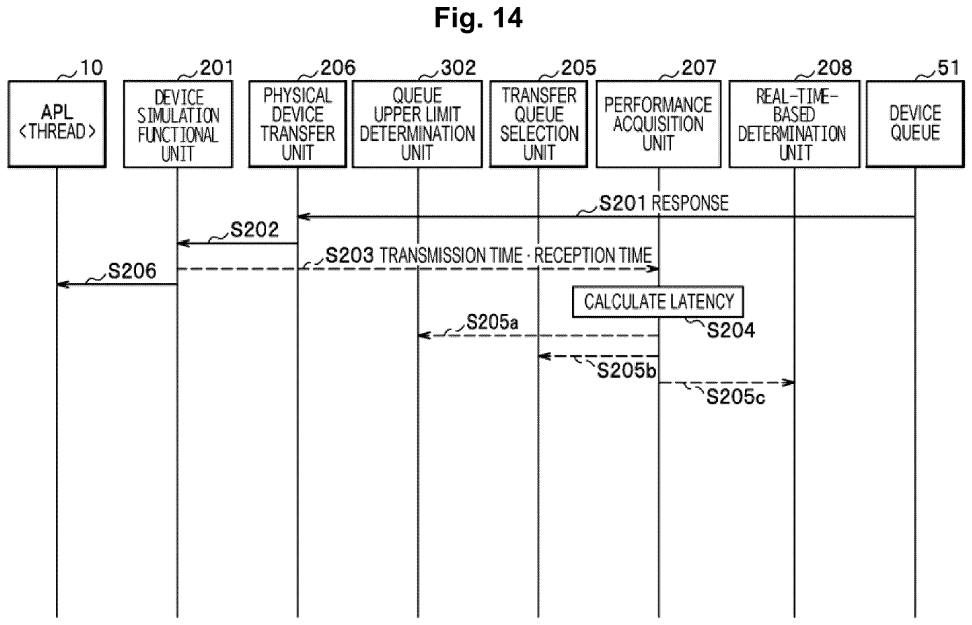

Next, processing executed by the accelerator offload device 1 is described. First, a flow (outward path) of a request from the application 10 to the device queue 51 of the accelerator 5 is described with reference to FIG. 13 and a flow (return path) of a response from the device queue 51 of the accelerator 5 to the application 10 is described with reference to FIG. 14, where the flows are executed by the accelerator offload device 1.

FIG. 13 is a sequence diagram of a flow of processing (outward path) executed by the accelerator offload device 1. First, the device simulation functional unit 201 receives a request from a thread of the application 10 (step S101).

The device simulation functional unit 201 enqueues the request in the reception queue 202 for the application corresponding to the received request (step S102). Note that the device simulation functional unit 201 remembers a time (transmission time) at which the request has been enqueued, in order to measure the latency. Specifically, the device simulation functional unit 201 acquires an APL_ID corresponding to the thread that has transmitted the received request, and enqueues the request in the reception queue 202 with the reception queue ID corresponding to the APL_ID, with reference to the reception queue information 210 (FIG. 2). Furthermore, the device simulation functional unit 201 outputs metadata acquired from the received request to the transfer queue determination unit 203 (step S103).

On acquiring the metadata, the transfer queue determination unit 203 determines the transfer queue 204 to have the request, dequeued from the reception queue 202, enqueued based on the priority of the request (step S104). Note that when priority information is included in the acquired metadata, the transfer queue determination unit 203 determines the priority by using the priority information. Furthermore, when priority information is not included in the acquired metadata and a remaining time budget (buffering time) for the request can be calculated on the basis of the imposed time slot, the transfer queue determination unit 203 outputs the information regarding the request to the real-time-based determination unit 208 and obtains information regarding whether or not to enqueue the request in the transfer queue 204 with higher priority (step S104a).

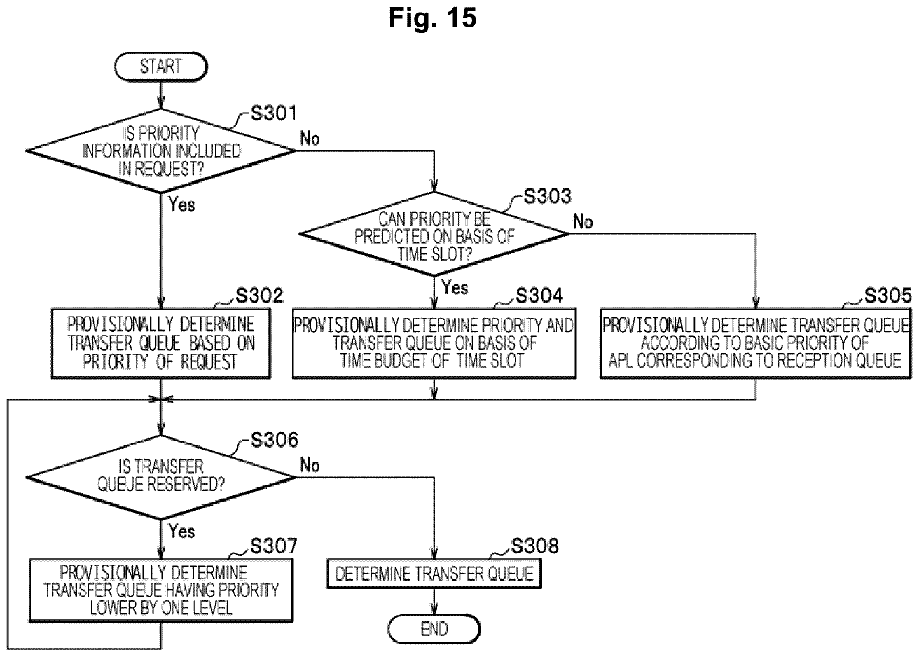

When priority information is not included in the metadata, the transfer queue determination unit 203 refers to the transfer queue determination information 220 (FIG. 3) to acquire a transfer queue ID corresponding to the reception queue ID, and determines the transfer queue 204 indicated by the transfer queue ID as the transfer queue 204 to have the request enqueued. That is, the transfer queue 204 having the basic priority set for the application 10 is determined as one to have the request enqueued. Furthermore, when priority information is included in the metadata, the transfer queue determination unit 203 determines the transfer queue 204 according to the priority as one to have the request enqueued. Moreover, when the transfer queue determination unit 203 has received, from the real-time-based determination unit 208, information indicating that the request is to be enqueued in the high-priority transfer queue 204 due to a little remaining time budget, the transfer queue determination unit 203 determines the transfer queue 204 having a priority higher than the basic priority, as one to have the request enqueued. Note that details of the transfer queue determination process is described below with reference to FIG. 15. Furthermore, details of the process of determining the priority on the basis of the buffering time (time budget) of the time slot is described below with reference to FIG. 16.

The transfer queue determination unit 203 outputs information regarding the transfer queue 204, which has been determined to have the request enqueued, to the reception queue 202 (step S105).

When the information regarding the transfer queue 204 to have the request in the reception queue 202 enqueued is received, the request is outputted to the transfer queue 204 having the determined priority (step S106).

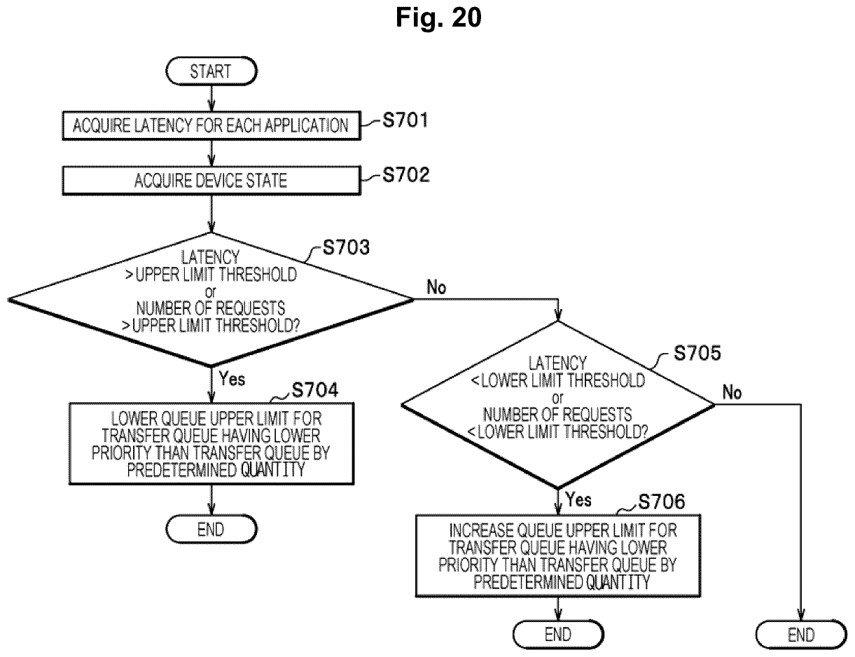

The transfer queue 204 buffers the request acquired from the reception queue 202. At that time, the transfer queue information 230 (FIG. 4) for the transfer queue 204 is referred to, and if the number of requests in the queue after the buffering exceeds the queue upper limit set for the transfer queue 204, the request cannot be enqueued, and thus the enqueuing from the reception queue 202 is stopped. Note that details of a queue upper limit determination process is described below with reference to FIG. 20.

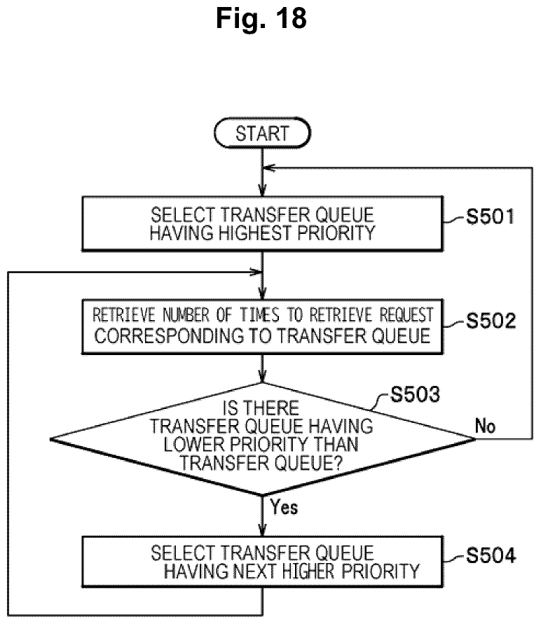

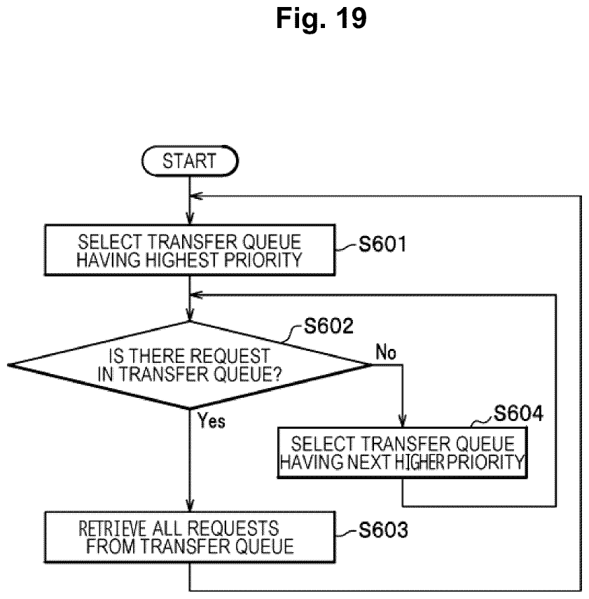

Next, the transfer queue selection unit 205 instructs dequeuing from the transfer queues 204 using a predetermined logic (transfer queue selection logic) (step S107). Note that the transfer queue selection logic is described below with reference to FIGS. 18 and 19. Then, the request instructed to be dequeued from the transfer queue 204 is outputted to the physical device transfer unit 206 (step S108).

On receiving the request from the transfer queue 204, the physical device transfer unit 206 enqueues the request in the device queue 51 of the accelerator 5 (step S109).

Next, a flow (return path) of a response from the device queue 51 of the accelerator 5 to the application 10, which is executed by the accelerator offload device 1, is described. FIG. 14 is a sequence diagram of a flow of processing (return path) executed by the accelerator offload device 1.

First, the physical device transfer unit 206 acquires a response to the request from the device queue 51 of the accelerator 5 (step S201). Then, the physical device transfer unit 206 outputs the response to the device simulation functional unit 201 (step S202).

The device simulation functional unit 201 outputs the transmission time remembered in step S102 of FIG. 13 and the time when the response has been acquired (reception time) to the performance acquisition unit 207 (step S203). Then, the performance acquisition unit 207 calculates a latency from a difference between the request transmission time and the response reception time (step S204). The performance acquisition unit 207 outputs information regarding the calculated latency to the queue upper limit determination unit 302, the transfer queue selection unit 205, and the real-time-based determination unit 208 (steps S205a, S205b, and S205c).

Furthermore, the device simulation functional unit 201 transmits the acquired response to the thread of the application 10 (step S206).

### Transfer Queue Determination Process

Next, the transfer queue determination process mainly executed by the transfer queue determination unit 203 is described in detail. FIG. 15 is a flowchart of the transfer queue determination process executed by the accelerator offload device 1 according to the present embodiment.

First, on acquiring the metadata added to the request from the device simulation functional unit 201, the transfer queue determination unit 203 determines whether or not the metadata of the request includes information (priority information) for determining the priority (step S301). Here, the case where the priority information is included is, for example, a case where priority indicating high priority or low priority is added to the request in advance as metadata.

When the priority information is included in the request (Yes in step S301), the transfer queue determination unit 203 provisionally determines a transfer queue based on the priority of the request (step S302).

In contrast, when the priority information is not included in the request (No in step S301), the transfer queue determination unit 203 determines whether the priority can be predicted on the basis of the buffering time (time budget) of the time slot (step S303). Then, when the transfer queue determination unit 203 has determined that the priority can be predicted on the basis of the buffering time of the time slot (Yes in step S303), the transfer queue determination unit 203 outputs the metadata of the request to the real-time-based determination unit 208, and the processing proceeds to step S304.

In step S304, the real-time-based determination unit 208 provisionally determines the priority and the transfer queue on the basis of the buffer time (time budget) of the time slot. Note that details of the priority determination processing by the real-time-based determination unit 208 is described below with reference to FIG. 16.

In contrast, when it is determined that the priority cannot be predicted based on the time slot (No in step S303), the transfer queue determination unit 203 acquires the transfer queue according to the basic priority of APL_ID corresponding to the reception queue 202, with reference to the transfer queue determination information 220 (FIG. 3), and provisionally determines the transfer queue 204 (step S305).

When the transfer queue 204 is provisionally determined in steps S302, S304, and S305, the transfer queue determination unit 203 determines whether or not the transfer queue 204 is reserved to be emptied by the band reservation unit 303 (step S306). Then, when the transfer queue 204 is reserved (Yes in step S306), the transfer queue determination unit 203 provisionally determines one having a priority lower by one level than that of the provisionally reserved transfer queue, as the transfer queue 204 (step S307), and returns to step S306.

In contrast, when the transfer queue 204 is not reserved (No in step S306) in step S306, the transfer queue determination unit 203 determines the transfer queue 204 as one to have the request enqueued (step S308), and ends the processing.

### Priority Determination Process Based on Time Budget of Time Slot

FIG. 16 is a flowchart of a priority determination process based on a time budget of a time slot. Furthermore, FIG. 17 is a diagram illustrating an example of the time slot. In a system in which a request is transmitted with a certain time slot as in vRAN, the real-time-based determination unit 208 determines the priority on the basis of the remaining time budget (buffer time), considering the latency acquired by the performance acquisition unit 207, even when there is no priority information in the metadata of the request.

On acquiring the metadata of the request from the transfer queue determination unit 203, the real-time-based determination unit 208 specifies the type of request (step S401). Then, the real-time-based determination unit 208 determines whether the type of request is emergency traffic (step S402). Here, the emergency traffic means traffic to be processed with a highest preset priority, such as error processing.

Then, when it is determined to be the emergency traffic (Yes in step S402), the real-time-based determination unit 208 sets the request to have the highest priority (step S414). In contrast, when it is determined that the traffic is not the emergency traffic (No in step S402), the processing proceeds to step S403.

In step S403, the real-time-based determination unit 208 acquires a start time t0 and an end time t3 of a time slot #Tn corresponding to a request #n. FIG. 17 illustrates the time slot #Tn for the request #n. It is necessary to complete the processing during the start time to and the end time t3 of the time slot #Tn (hereinbelow, refer to FIG. 17 as appropriate).

Subsequently, the real-time-based determination unit 208 acquires a current time t1 (step S404). Then, a performance value P corresponding to the application 10, as the type of request, is acquired (step S405). Here, the performance value P is a latency calculated by the performance acquisition unit 207.

Next, the real-time-based determination unit 208 calculates a predicted response completion time t2 by Equation (1) below (step S406).

t2=t1+P Equation (1)

Then, the real-time-based determination unit 208 calculates a buffer time B by Equation (2) below (step S407)

B=t3−t2 Equation (2)

Next, the real-time-based determination unit 208 determines whether the basic priority of the request is equal to or higher than a predetermined priority (step S408). Here, when the priority is not equal to or higher than the predetermined priority (No in step S408), the processing proceeds to step S415, and the priority is not changed. This is to exclude a change in priority for a low priority request that is not equal to or higher than the predetermined priority since it is not necessary to change the request, originally allowed to be processed with a low priority, so as to have a high priority. In contrast, when a priority is equal to or higher than the predetermined priority (Yes in step S408), the processing proceeds to step S409.

In step S409, the real-time-based determination unit 208 compares the buffer time B with a time-rich buffer time B2 (second buffer time threshold), and determines whether or not a condition of B>B2 and the current priority (basic priority) being not minimum is satisfied.

This means that, when the buffer time B is larger than the time-rich buffer time B2, there is enough time left for processing the request. Therefore, when the condition of B>B2 and the current priority being not the minimum (Yes in step S409) is satisfied, the priority is lowered by one level from the current priority (basic priority) (step S410) In contrast, when the condition of B>B2 and the current priority being not the minimum is not satisfied (No in step S409), the processing proceeds to step S411.

In step S411, the real-time-based determination unit 208 compares the buffer time B with a time-poor buffer time B1 (first buffer time threshold: a predetermined time threshold), and determines whether or not a condition of that 0<B<B1 and the current priority being not maximum is satisfied. This means that, when the buffer time B is smaller than the time-poor buffer time B1, there is not enough time left for processing the request. Thus, when the condition of 0<B<B1 and the current priority being not the maximum is satisfied (Yes in step S411), the priority is increased by one level from the current priority (basic priority) (step S412). In contrast, when the condition of 0<B<B1 and the current priority being not the maximum is not satisfied (No in step S411), the processing proceeds to step S413.

In step S413, the real-time-based determination unit 208 determines whether or not a condition of B<0 and the current priority being not the maximum is satisfied. This means that, since the buffer time has a negative value, the request to be prioritized needs to be set to have the highest priority. Thus, when the condition of B<0 and the current priority being not the maximum is satisfied (Yes in step S413), the current priority (basic priority) is set to the highest priority (step S414). In contrast, when the condition of B<0 and the current priority being not the maximum is not satisfied (No in step S413), the processing ends without changing the priority (step S415).

As described above, even when there is no priority information in the metadata of the request, the real-time-based determination unit 208 can determine the priority by predicting the buffer time (time budget).

### Transfer Queue Selection Process

Next, the transfer queue selection process executed by the transfer queue selection unit 205 is described. The transfer queue selection process is executed on the basis of a predetermined logic (transfer queue selection logic) set in the transfer queue selection unit 205. As the transfer queue selection logic, the weighted round robin processing (FIG. 18) or the priority order processing (FIG. 19) is adopted.

FIG. 18 is a flowchart of the transfer queue selection process using the weighted round robin processing First, the transfer queue selection unit 205 selects the transfer queue 204 having the highest priority (step S501). Next, the transfer queue selection unit 205 refers to the transfer queue selection information 240 (FIG. 5) to retrieve a retrieving ratio (the number of times to retrieve a request) corresponding to the transfer queue 204 (step S502). That is, the transfer queue selection unit 205 transmits dequeue instructions corresponding to the retrieving ratio (the number of times to retrieve a request) to the transfer queue 204.

Next, the transfer queue selection unit 205 determines whether or not there is a transfer queue 204 having a lower priority than the transfer queue (step S503). Then, when there is no transfer queue 204 having a lower priority than the transfer queue (No in step S503), the processing returns to step S501. In contrast, when there is a transfer queue 204 having a lower priority than the transfer queue (Yes in step S503), the transfer queue selection unit 205 selects the transfer queue 204 having the next higher priority (step S504), and returns to step S502.

In this manner, the transfer queue selection unit 205 can dequeue a request from the transfer queues 204 having respective priorities, on the basis of the retrieving ratios set in the transfer queue selection information 240 (FIG. 5).

FIG. 19 is a flowchart of the transfer queue Selection process using priority order processing. First, the transfer queue selection unit 205 selects the transfer queue 204 having the highest priority (step S601).

Next, the transfer queue selection unit 205 determines whether or not there are one or more requests in the transfer queue 204 (step S602). When there are one or more requests (Yes in step S602), the processing proceeds to step S603. In step S603, the transfer queue selection unit 205 issues one or more dequeue instructions to the transfer queue 204 so as to retrieve all the requests from the transfer queue 204. Then, the processing returns to step S601.

In contrast, when there is no request in step S602 (No in step S602), the transfer queue selection unit 205 selects the transfer queue 204 having the next higher priority (step S604), and returns to step S602.

In this manner, the transfer queue selection unit 205 can dequeue the one or more requests from the transfer queues 204 having respective priorities, in preference to the transfer queues 204 having higher priorities.

### Queue Upper Limit Determination Process

Next, a queue upper limit determination process executed by the queue upper limit determination unit 302 or the like is described. FIG. 20 is a flowchart of the queue upper limit determination process executed by the accelerator offload device 1 according to the present embodiment.

First, the performance acquisition unit 207 acquires a latency for each application 10 from an interval between a request made between the application 10 and the accelerator 5 and a response to the request (step S701).

Then, the performance acquisition unit 207 outputs the acquired latency to the queue upper limit determination unit 302.

Next, the device state acquisition unit 301 acquires a device state by counting the number of requests staying in the accelerator 5 (step S702). Then, the device state acquisition unit 301 acquires the number of staying requests (or a latency predicted from the number of requests), and outputs the number of staying requests to the queue upper limit determination unit 302.

The queue upper limit determination unit 302 refers to the application performance information 250 (FIG. 8) and the information stored in the storage unit regarding the upper limit threshold for the number of staying requests, to determine whether the latency exceeds the upper limit threshold or whether the number of staying requests (or a predicted latency) exceeds the upper limit threshold (step S703).

When either the latency or the number of staying requests exceeds the corresponding upper limit threshold (Yes in step S703), the queue upper limit determination unit 302 lowers the queue upper limit for a transfer queue 204 having a lower priority than the transfer queue 204 by a predetermined quantity (step S704).

In contrast, when neither the latency nor the number of staying requests (or the predicted latency) exceeds the corresponding upper limit threshold in step S703 (No in step S703), the processing proceeds to step S705.

In step S705, the queue upper limit determination unit 302 refers to the application performance information 250 (FIG. 8) and the information stored in the storage unit regarding the lower limit threshold for the number of staying requests, to determine whether the latency is less than the lower limit threshold or whether the number of staying requests (or the predicted latency) is less than the lower limit threshold.

When either the latency or the number of staying requests is less than the corresponding lower limit threshold (Yes in step S705), the queue upper limit determination unit 302 increases the queue upper limit for a transfer queue 204 having a lower priority than the transfer queue 204 by a predetermined quantity (step S706).

In contrast, when neither the latency nor the number of staying requests (or the predicted latency) is less than the corresponding lower limit threshold in step S705 (No in step S705), the queue upper limit determination unit 302 ends the processing without changing the queue upper limit.

### Queue Selection Ratio Determination Process

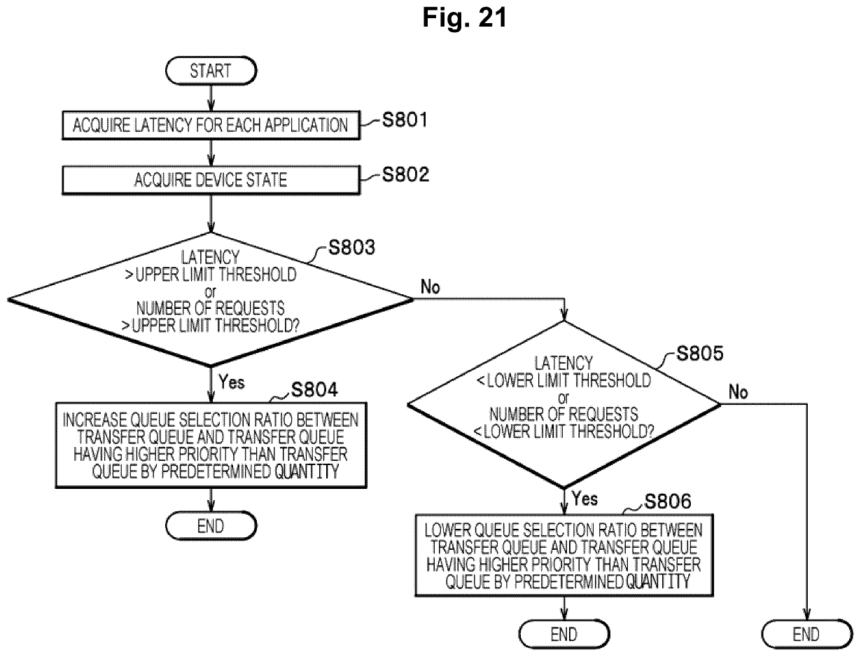

Next, the queue selection ratio determination process executed by the transfer queue selection unit 205 is described. FIG. 21 is a flowchart of the queue selection ratio determination process executed by the accelerator offload device 1 according to the present embodiment.

First, the performance acquisition unit 207 acquires a latency for each application 10 from an interval between a request made between the application 10 and the accelerator 5 and a response to the request (step S801). Then, the performance acquisition unit 207 outputs the acquired latency to the transfer queue selection unit 205.

Next, the device state acquisition unit 301 acquires a device state by counting the number of requests staying in the accelerator 5 (step S802). Then, the device state acquisition unit 301 acquires the number of staying requests (or a latency predicted from the number of requests), and outputs the number of staying requests to the transfer queue selection unit 205.

The transfer queue selection unit 205 refers to the application performance information 250 (FIG. 8) and the information stored in the storage unit regarding the upper limit threshold for the number of staying requests, to determine whether the latency exceeds the upper limit threshold or whether the number of staying requests for a predicted latency) exceeds the upper limit threshold (step S803).

When either the latency or the number of staying requests exceeds the corresponding upper limit threshold (Yes in step S803), the transfer queue selection unit 205 increases the queue selection ratio (retrieving ratio) between the transfer queue 204 and a transfer queue 204 having a higher priority than the transfer queue 204 by a predetermined quantity (step S804).

In contrast, when neither the latency nor the number of staying requests (or the predicted latency) exceeds the corresponding upper limit threshold in step S803 (No in step S803), the transfer queue selection unit 205 proceeds to step S805.

In step S805, the transfer queue selection unit 205 refers to the application performance information 250 (FIG. 8) and the information stored in the storage unit regarding the lower limit threshold for the number of staying requests, to determine whether the latency is less than the lower limit threshold or whether the number of staying requests (or the predicted latency) is less than the lower limit threshold.

Then, when either the latency or the number of staying requests is less than the lower limit threshold (Yes in step S805), the transfer queue selection unit 205 lowers the queue selection ratio (retrieving ratio) between the transfer queue 204 and a transfer queue 204 having a higher priority than the transfer queue 204 by a predetermined quantity (step S806).

In contrast, when neither the latency nor the number of staying requests (or the predicted latency) is less than the lower limit threshold in step S805 (No in step S805), the transfer queue selection unit 205 ends the processing without changing the queue selection ratio (retrieving ratio).

### Hardware Configuration

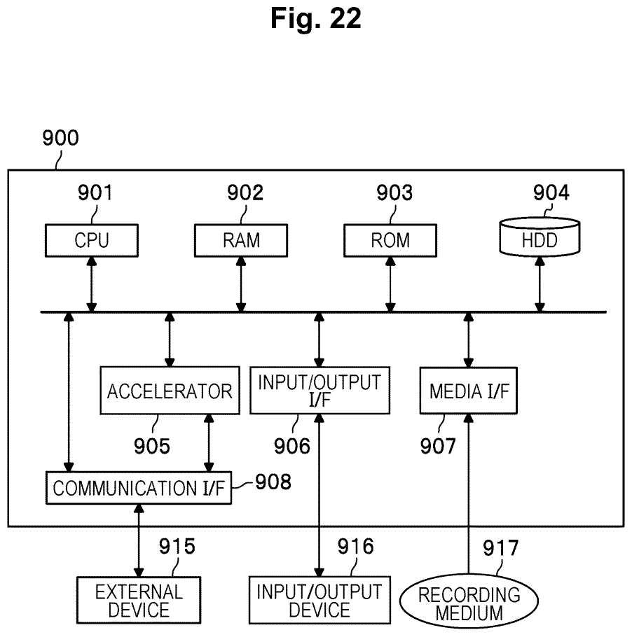

The accelerator offload device 1 according to the above-described embodiment is implemented by, for example, a computer 900 having a configuration illustrated in FIG. 22. FIG. 22 shows an example hardware configuration of the computer 900 that implements the functions of the accelerator offload device 1. The computer 900 includes a CPU 901, a RAM 902, a ROM 903, an HDD 904, an accelerator 905, an input/output interface (I/F) 906, a media interface (I/F) 907, and a communication interface (I/F) 908. The accelerator 905 corresponds to the accelerator 5 in FIG. 1.

The accelerator 905 is the accelerator 5 (FIG. 1) that processes, at high speed, at least one of data from the communication I/F 908 and data from the RAM 902. Note that the accelerator 905 may be of a type (look-aside type) that executes processing from the CPU 901 or the RAM 902 and then returns the execution results to the CPU 901 or the RAM 902. Alternatively, the accelerator 905 may be of a type (in-line type) that is interposed between the communication I/F 908 and the CPU 901 or the RAM 902 and performs processing.

The accelerator 905 is connected to an external device 915 via the communication I/F 908. The input/output I/F 906 is connected to an input/output device 916. The media I/F 907 reads and writes data from and to a recording medium 917.

The CPU 901 operates on the basis of a program stored in the ROM 903 or the HDD 904 and controls components of the accelerator offload device 1 in FIG. 1 by executing the program (application) retrieved into the RAM 902. Then, the program may be distributed via a communication line or recorded and distributed in the recording medium 917 such as a CD-ROM. The ROM 903 stores a boot program to be executed by the CPU 901 when the computer 900 is activated, a program depending on hardware of the computer 900, and the like.

The CPU 901 controls the input/output device 916 including an input unit such as a mouse and a keyboard and an output unit such as a display and a printer, via the input/output I/F 906. The CPU 901 acquires data from the input/output device 916 and outputs generated data to the input/output device 916, via the input/output I/F 906.

The HDD 904 stores a program to be executed by the CPU 901, data to be used by the program, and the like. The communication I/F 908 receives data from another device via a communication network (such as a network (NW) ) and outputs the data to the CPU 901, and also transmits data generated by the CPU 901 to another device via the communication network.

The media I/F 907 retrieves a program or data stored in the recording medium 917 and outputs the program or data to the CPU 901 via the RAM 902. The CPU 901 loads a program used for intended processing from the recording medium 917 into the RAM 902 via the media I/F 907 and executes the loaded program. The recording medium 917 is an optical recording medium such as a digital versatile disc (DVD) and a phase change rewritable disk (PD), a magneto-optical recording medium such as a magneto optical disk (MO), a magnetic recording medium, a conductor memory tape medium, a semiconductor memory, or the like.

For example, when the computer 900 functions as the accelerator offload device 1 configured as a device according to the present embodiment, the CPU 901 of the computer 900 implements the functions of the accelerator offload device 1 by executing the program loaded into the RAM 902. Furthermore, the HDD 904 may store data existing in the RAM 902. The CPU 901 retrieves the program used for the intended processing from the recording medium 917 and executes the program. In addition, the CPU 901 may retrieve the program used for the intended processing from another device via the communication network.

### Advantageous Effects

Hereinbelow, advantageous effects of the accelerator offload device 1 according to the present invention and the like is described. The accelerator offload device according to the present invention is the accelerator offload device 1 that has the accelerator 5 and offloads processing of a plurality of the applications 10 having different performance requirements to the accelerator 5. The accelerator offload device 1 includes: the device simulation functional unit 201 that implements an interface function equivalent to that of the accelerator 5 to pretend to communicate with the accelerator 5, receives requests from the applications 10, and enqueues the requests in reception queues 202 corresponding to the applications 10; the transfer queue determination unit 203 that acquires metadata attached to the received requests and determines, per request, the transfer queues 204 Corresponding to basic priorities indicating priorities of the applications 10, based on the performance requirements, as those into which the requests stored in the reception queues 202 are enqueued; the reception queues 202 that are respectively provided for the applications 10 to buffer the requests, and have the requests enqueued therefrom into the transfer queues 204 determined by the transfer queue determination unit 203; the transfer queue selection unit 205 that performs a dequeue instruction to dequeue the requests in preference to the transfer queues having high priorities, using a predetermined transfer queue selection logic, based on priorities associated with the transfer queues 204; and the transfer queues 204 that are provided per priority to buffer the requests, and have the requests outputted to the device queue 51 of the accelerator 5 according to dequeue instructions.

With this configuration, the accelerator offload device 1 can prevent performance deterioration of the applications 10 even in a case of offloading processing from a plurality of the applications 10 having different performance requirements to the single accelerator 5. Thus, the accelerator offload device 1 can offload processing to the single accelerator 5, even when the offloading to the single accelerator 5 cannot be performed with a conventional technique due to strict performance requirements, to reduce consumed electricity.

Furthermore, the accelerator offload device 1 secures performance of the high-priority application 10 in a system that has processing already offloaded from a plurality of the applications 10 to the single accelerator 5, to improve service quality. Moreover, the accelerator offload device 1 can eliminate traffic limitation for avoiding performance impact in the system that has processing already offloaded from a plurality of the applications 10 to the single accelerator 5, to allow for processing more traffic.

Furthermore, the accelerator offload device 1 further includes the queue upper limit determination unit 302 that sets a queue upper limit indicating an upper limit of the number of requests that can be enqueued for the respective transfer queues 204, wherein if the queue upper limit is exceeded when a new request is to be enqueued in the transfer queue 204, the enqueuing of the new request from the reception queue 202 is stopped.

As described above, the accelerator offload device 1 can stop enqueuing low-priority requests from the reception queue 202 by setting the queue upper limit for the transfer queue 204, to allow for processing in preference to high priority requests. Thus, the accelerator offload device 1 can further reduce the performance impact among a plurality of the applications 10 having different performance requirements.

Furthermore, the accelerator offload device 1 further includes the performance acquisition unit 207 that acquires a performance delay value, indicating a latency, from a request transmission time and a response reception time between the application 10 and the accelerator 5, wherein the transfer queue selection unit 205 changes the transfer queue selection logic when the latency exceeds a predetermined upper limit threshold, to increase a frequency of dequeuing requests from the transfer queues 204 having a high priority, as compared with a current frequency.

As described above, when the latency of the high-priority request exceeds a predetermined upper limit threshold, the accelerator offload device 1 can process, in more preference to, the high-priority request. Thus, the accelerator offload device 1 can further reduce performance impact among a plurality of the applications 10 having different performance requirements.

Furthermore, the accelerator offload device 1 further includes the performance acquisition unit 207 that acquires a performance delay value, indicating a latency, from a request transmission time and a response reception time between the application 10 and the accelerator 5, wherein the queue upper limit determination unit 302 lowers the queue upper limit set for the transfer queue 204 corresponding to the application by a predetermined quantity when the latency exceeds a predetermined upper limit threshold.

As described above, when the latency of the high-priority request exceeds a predetermined upper limit threshold, the accelerator offload device 1 can lower the queue upper limit set for the transfer queue 204, to allow for processing, in more preference to, the high-priority request. Thus, the accelerator offload device 1 can further reduce performance impact among a plurality of the applications 10 having different performance requirements.

Furthermore, the accelerator offload device 1 further includes the device state acquisition unit 301 that acquires the number of requests staying in the accelerator 5, wherein the transfer queue selection unit 205 changes the transfer queue selection logic when the number of staying requests exceeds a predetermined upper limit threshold, to increase a frequency of dequeuing requests from the transfer queues 204 having a high priority, as compared with a current frequency.

As described above, when the number of requests staying in the accelerator 5 exceeds a predetermined upper limit threshold, the accelerator offload device 1 can process, in more preference to, the high-priority request. Thus, the accelerator offload device 1 can further reduce performance impact among a plurality of the applications 10 having different performance requirements.

Furthermore, the accelerator offload device 1 further includes the device state acquisition unit 301 that acquires the number of requests staying in the accelerator 5, wherein when the number of staying requests exceeds a predetermined upper limit threshold, the queue upper limit determination unit 302 lowers the queue upper limit set for the transfer queue 204 corresponding to the application 10 by a predetermined quantity.

As described above, when the number of requests staying in the accelerator 5 exceeds a predetermined upper limit threshold, the accelerator offload device 1 can lower the queue upper limit set in the transfer queue 204, to allow for processing, in more preference to, the high-priority request. Thus, the accelerator offload device 1 can further reduce performance impact among a plurality of the applications 10 having different performance requirements.

Furthermore, the accelerator offload device 1 further includes the real-time-based determination unit 208 that calculates a time budget remaining for the request when the metadata attached to the received request does not include priority information indicating information for determining the priority of the request, and executes control so as to increase the priority of the request from the basic priority determined by the transfer queue determination unit 203 when the calculated time budget is smaller than a predetermined time threshold.

As described above, the accelerator offload device 1 can allocate the request with a small time budget to the high-priority transfer queue 204. Thus, the accelerator offload device 1 can further reduce performance impact among a plurality of the applications 10 having different performance requirements.

Furthermore, the accelerator offload device 1 further includes the band reservation unit 303 that acquires prediction information regarding an increase in traffic of the requests and outputs, to the transfer queue determination unit 203, an instruction to stop enqueuing requests in a high-priority transfer queue in advance.

As described above, the accelerator offload device 1 can minimize a delay of the request when it is predicted that requests are transmitted in bursts. Thus, the accelerator offload device 1 can further reduce performance impact among a plurality of the applications 10 having different performance requirements.

Note that the present invention is not limited to the above-described embodiment, and many modifications can be made by those skilled in the art within the technical idea of the present invention.

### REFERENCE SIGNS LIST

1 Accelerator offload device
5 Accelerator (ACC)
7 External controller
10 Application (APL)
20 Packet processing unit
30 Offload management unit
50 HW
51 Device queue
52 IP core
55 VF
201 Device simulation functional unit
202 Reception queue
203 Transfer queue determination unit
204 Transfer queue
205 Transfer queue selection unit
206 Physical device transfer unit
207 Performance acquisition unit
208 Real-time-based determination unit
210 Reception queue information
220 Transfer queue determination information
230 Transfer queue information
240 Transfer queue selection information
250 Application performance information
301 Device state acquisition unit
302 Queue upper limit determination unit
303 Band reservation unit

1. An accelerator offload device that includes an accelerator and offloads processing of a plurality of applications having different performance requirements to the accelerator, the device comprising:
a device simulation functional unit that implements an interface function equivalent to that of the accelerator to pretend to communicate with the accelerator, receives requests from the applications, and enqueues the requests in reception queues of the device corresponding to the applications;
a transfer queue determination unit that acquires metadata attached to the received requests and determines, per request, transfer queues of the device corresponding to basic priorities indicating priorities of the applications according to the performance requirements, as those into which the requests stored in the reception queue are enqueued; and
a transfer queue selection unit that executes dequeue instructions to dequeue the requests in preference to the transfer queues having higher priorities, using a predetermined transfer queue selection logic, based on priorities associated with the transfer queues,
wherein
the reception queues are respectively provided for the applications to buffer the requests, and have the requests enqueued therefrom into the transfer queues determined by the transfer queue determination unit, and
the transfer queues are provided per priority to buffer the requests, and have the requests outputted to a device queue of the accelerator according to the dequeue instructions.

2. The accelerator offload device according to claim 1, further comprising a queue upper limit determination unit that sets a queue upper limit indicating an upper limit of the number of requests that can be enqueued for the respective transfer queues,
wherein if the queue upper limit is exceeded when a new request is to be enqueued in the transfer queue, the enqueuing of the new request from the reception queue is stopped.

3. The accelerator offload device according to claim 1 , further comprising a performance acquisition unit that acquires a performance delay value, indicating a latency, from a request transmission time and a response reception time between the application and the accelerator,
wherein the transfer queue selection unit changes the transfer queue selection logic when the latency exceeds a predetermined upper limit threshold, to increase a frequency of dequeuing requests from the transfer queues having a high priority, as compared with a current frequency.

4. The accelerator offload device according to claim 2, further comprising a performance acquisition unit that acquires a performance delay value, indicating a latency, from a request transmission time and a response reception time between the application and the accelerator,
wherein the queue upper limit determination unit lowers the queue upper limit set for the transfer queue corresponding to the application by a predetermined quantity when the latency exceeds a predetermined upper limit threshold.

5. The accelerator offload device according to claim 1, further comprising a device state acquisition unit that acquires the number of requests staying in the accelerator,
wherein the transfer queue selection unit changes the transfer queue selection logic when the number of staying requests exceeds a predetermined upper limit threshold, to increase a frequency of dequeuing requests from the transfer queues having a high priority, as compared with a current frequency.

6. The accelerator offload device according to claim 2, further comprising a device state acquisition unit that acquires the number of requests staying in the accelerator,
wherein when the number of staying requests exceeds a predetermined upper limit threshold, the queue upper limit determination unit lowers the queue upper limit set for the transfer queue corresponding to the application by a predetermined quantity.

7. The accelerator offload device according to claim 1, further comprising a real-time-based determination unit that calculates a time budget remaining for the request when metadata attached to the received request does not include priority information indicating information for determining the priority of the request, and executes control so as to increase the priority of the request from the basic priority determined by the transfer queue determination unit when the calculated time budget is smaller than a predetermined time threshold.

8. The accelerator offload device according to claim 1, further comprising a band reservation unit that acquires prediction information regarding an increase in traffic of the requests and outputs, to the transfer queue determination unit, an instruction to stop enqueuing requests in a high-priority transfer queue in advance.

9. An accelerator offload method of an accelerator offload device that includes an accelerator and offloads processing of a plurality of applications having different performance requirements to the accelerator, the method comprising:
a step of implementing an interface function equivalent to that of the accelerator to pretend to communicate with the accelerator, receiving requests from the applications, and enqueuing the requests in reception queues corresponding to the applications;
a step of acquiring metadata attached to the received requests and determining, per request, transfer queues corresponding to basic priorities indicating priorities of the applications according to the performance requirements, as those into which the requests stored in the reception queue are enqueued; and
a step of executing dequeue instructions to dequeue the requests in preference to the transfer queues having higher priorities, using a predetermined transfer queue selection logic, based on priorities associated with the transfer queues,
wherein
the reception queues are respectively provided for the applications to buffer the requests, and have the requests enqueued therefrom into the determined transfer queues, and
the transfer queues are provided per priority to buffer the requests, and have the requests outputted to a device queue of the accelerator according to the dequeue instructions.

10. A non-transitory computer-readable medium storing a program which, when executed by one or more processors, to cause the one or more processors to execute the accelerator offload method device according to claim 9.
